(19) United States
(12) Patent Application Publication
(10) Pub. No.: US 2011/0023268 A1
(43) Pub. Date: Feb. 3, 2011

(54) MULTI-WHEEL CASTER

(76) Inventor: Victor Dole Smith, San Jose, CA (US)

Correspondence Address: DONALD W. MEEKER, 924 EAST OCEAN FRONT, # E, NEWPORT BEACH, CA, 92661, US

(21) Appl. No.: 12/511,235

(22) Filed: Jul. 29, 2009

(51) Int. Cl. B60B 33/00

(52) U.S. Cl. 16/47

(57) ABSTRACT

A multi-wheel caster apparatus has a main, surface-contacting wheel, an inline small diameter wheel elevated in front of the main riding wheel, and a third offset mid-sized diameter wheel. The offset wheel is in parallel alignment with and mounted midway between the two inline wheels. The apparatus is mounted to the bottom of a cart, with both stationary and swivel mounting. The offset wheel keeps the wheel housing compact and the elevated wheels maintain a low center of gravity while traveling easily over obstacles.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to multi-wheeled casters and particularly to a multi-wheel caster with a main riding wheel, a small wheel elevated in front of the main riding wheel, and a third offset mid-sized wheel which is positioned to fill in the gap between the main wheel and the small elevated wheel.

2. Description of Related Art Including Information Disclosed Under 37 CFR 1.97 and 1.98

The small diameter of conventional caster wheels makes negotiating even small obstacles difficult. Increasing the diameter of caster wheels reduced the around of force applied in overcoming obstacles in proportion to the height at which the wheel diameter contacts the heights of the obstacle. Unfortunately, the destabilizing effect of raising the center of mass of the card load out-weighs the advantages of increasing the caster wheel diameter.

Through trial and error, or empirical verification, caster wheel diameters are kept as small as possible. The need to keep the center of mass on the cart as low and as stable as possible requires the smallest diameter caster wheel which can still negotiate the obstacles which will be encountered. It is therefore necessary for the cart “operator” to apply the full amount of instantaneous acceleration energy to overcome the obstacles while not tipping the cart. The repeated application of this lifting and then stabilizing force is not always successful and exposes the operator to stress injury.

A force equal to the mass of the load being carried on the cart must be exerted upward against the cart load to the height of the obstacle encountered. The rate at which the force is applied upward is proportional to the rate at which the wheel is able to overcome the vertical distance. With a small diameter conventional caster wheel a relatively small obstacle is all that is needed to create a jarring and abrupt half once halted by any number of objects, the vertical force must quickly be applied to the entire weight of the cart to overcome the obstruction. This application of lifting force is difficult, it destabilizes the motion of the cart and will result in physical injury.

Conventional casters, in their simplest iteration roll or rotate in one vertical plane. Often a second plane of rotation at 90 degrees is introduced into the design to provide steer-ability. In the first and simplest scenario the wheel rotates around an axle, usually through a friction reducing bearing, with the axle secured in a simple frame piece which extends along each side of the wheel. In the second case where steer ability is introduced, the supporting frame has a shaft with a bearing attached to it such that it is allowed to rotate on a horizontal plane.

While the published patent application #20030122327 uses a three-wheel assembly, that published application uses relatively large wheels to be mounted on a wheel chair or a device for assisting in walking. None of the prior art patents provide low center of gravity three wheel castors for traveling easily over obstacles.

U.S. Patent Application #20030122327, published Jul. 3, 2003 by Wu, indicates a miracle curb climber including a casing having a top connecting bolt for screwing to a front or a rear axle of a walking aid, such as a handcart, a wheelchair, an electric wheelchair, a wheeled power chair, etc., at least one front pilot wheel and at least one main land-contacting wheel mounted into front and rear end of the casing, respectively, and at least one relaying wheel mounted in the casing between the pilot wheel and the land-contacting wheel. The front pilot wheel and the relaying wheel have diameters smaller than that of the main land-contacting wheel and are suspended in the air in front of the main land-contacting wheel, enabling the main land-contacting wheel to smoothly climb up a raised obstacle, such as a curb or a threshold, at a reduced angle of climbing without causing violent vibration or sway of the walking aid.

U.S. Pat. No. 2,197,273, issued Apr. 16, 1940 to Lindeman, discloses a wheel mounting for land vehicles and further discloses in FIGS. 6 and 7 a truck that has three wheels, one positioned fore, one positioned aft and an offset wheel between the fore and aft wheels to allow a smoother ride over uneven terrain.

U.S. Pat. No. 2,713,179, issued Jul. 19, 1955 to Clifton, is for a steerable dolly having a plurality of casters, each caster comprising a mounting plate, a truck assembly and at least two wheels for steerably supporting large heavy loads up and down inclines or around curves

U.S. Pat. No. 3,724,022, issued Apr. 3, 1973 to Alberti et al, provides a swiveling base carrying a low profile axle supporting structure with three or more caster wheels arranged in a triangular supporting and conveying pattern for distributing the load and thereby being capable of continuously achieving automatic alignment with associated receiving cargo. In addition, the feature of receiving cargo is improved by the conical edge design of the swivel base and the spring loaded mounting of the base structure.

U.S. Pat. No. 4,327,462, issued May 4, 1982 to Eggleston, shows a multi-wheel bed roller having three wheels disposed respectively between the depending flanges of an inverted U-shaped horn frame and upon respectively outer sides of the horn frame flanges all having conforming tread portions and the outer side wheels having smooth outer sides with the horn frame swivel mounted by means of an upwardly disposed stem. The wheels are freely mounted on an axle extending through the flanges of the horn frame so that they may rotate forwardly or rearwardly as the horn frame swivels about the vertical stem.

U.S. Pat. No. 5,075,924, issued Dec. 31, 1991 to Estkowski et al, claims a tilted axle multiple wheel caster for supporting an article of furniture and for rolling over a surface including a body having a first axle and a second axle with the first axle being disposed at an angle to a second axle and the first and second axles being disposed at acute angles to the surface. Two or more wheels are mounted for rotation about the first axle with each wheel being relatively rotatable with respect to each other wheel. Two or more wheels are also mounted for rotation about the second axle with each wheel being relatively rotatable with respect to each other wheel.

Four U.S. Pat. No. 5,507,069 issued Apr. 16, 1996; U.S. Pat. No. 7,146,683 issued Dec. 12, 2006; U.S. Pat. No. 7,500,285 issued Mar. 10, 2009 and U.S. Pat. No. 7,506,405 issued Mar. 24, 2009 to Willis, describe an articulated caster which provides a base having more than two casters attached thereto and disposed radially away from the approximate geometric center of the base. A pivot arm includes a pivot housing for receiving and maintaining a pivot ball therein. The pivot housing and pivot ball respectively each are provided with a pivot housing hole and a pivot ball hole which align together when the pivot ball is correctly disposed within the pivot housing. The pivot arm is pivotally attached to the base about a point that is disposed within the pivot ball by a shaft passing through the pivot ball hole, the pivot housing hole, and a pair of holes formed in opposing side walls of the base. According to a preferred modification, an angled slot is provided that is disposed in at least one side of the pivot housing having a width approximately equal to the diameter of the pivot ball hole. The angled slot is preferably disposed so that the bottom thereof is generally in closer proximity to a front of the base than is the top of the angled slot. The shaft passes through and cooperates with the angled slot so that the side to side pivotal motion of the pivot arm with respect to the front of the base is limited to the motion by the shaft within the area as defined by the angled slot.

U.S. Pat. No. 4,494,464, issued Jan. 22, 1985 to Fujita et al, shows a wheeled carriage which is capable of moving on rails to-and-fro, and of moving on a railless flat floor in any desired direction. The carriage has at least three pivotable wheel units. Each of these units consists of a first wheel and a second wheel. The first wheel comprises a core wheel portion and a raised peripheral wheel portion surrounding the latter. The second wheel resembles substantially the core wheel portion of the first wheel. The wheel unit is designed for making two contact points with rails when seen at its side view and equally two contact points with rails when seen at its front or rear view.

U.S. Pat. No. 350,636, issued Oct. 12, 1886 to Otis, provides a furniture castor having a large wheel and a spaced small wheel both pivotally mounted on a bracket which attaches to the piece of furniture by a novel pivotal spindle.

What is needed is low center of gravity three wheel castors for traveling easily over obstacles.

### BRIEF SUMMARY OF THE INVENTION

An object of the present invention is to provide two inline wheels and at least one offset parallel wheel mounted midway between the first two in a single multiple caster housing creating a low center of gravity three wheel castor for traveling easily over obstacles.

An additional object of the present invention is to provide a wheel apparatus in which the rear ground-contacting wheel is the largest of the wheels, with the remaining wheels being incrementally smaller and more elevated in the wheel housing.

Another object of the present invention is to provide compactness of the wheel housing by having at least one wheel offset.

One more object of the present invention is to provide a swivel attachment for the multi-wheel caster if necessary.

In brief, the present invention provides a multi-wheel caster with a main riding wheel, a small wheel elevated in front of the main riding wheel, and a third offset mid-sized wheel which is positioned to fill in the gap between the main wheel and the small elevated wheel.

The simplicity of the present invention is nearly as salient as its ability to easily negotiate obstacles. They will have no fulcrum, no springs, no levers, essentially no mechanical movement save wheel rotation common to all casters.

The present invention is essentially a minor but strategic modification of these very simple and well established designs. Conventional casters have no moving parts, save the wheel and the bearing to allow steering. The present invention, similarly, has no moving parts, save the wheels and the conventional shaft and bearing configuration which allows steer ability.

The simple frame piece of a conventional caster is simply expanded in the present invention to accommodate additional wheels. These wheels roll, or rotate in the same vertical plane as a conventional caster. The frame piece just holds one or more wheels to the side of a conventionally configured wheel, and one or more wheels in front of the conventional wheel.

The housing holds the additional wheels in gradually increasing heights from the floor contacting wheel. The additional wheels in my design will be in most applications, of decreasing diameter as their mounting distance from the conventional wheel increases.

The solution to this energy input and stability trade off is found in the present invention. By placing smaller diameter wheels in front of and above the conventional wheels, the lifting force is distributed into smaller, more manageable increments. Similarly, if one must lift oneself from the first floor of a building to the second floor, one exerts the same amount of lifting force whether one climbs a rope or uses the stairs. The stairs are considerable easier than the rope because the total amount of force is distributed in smaller and more manageable increments. The wheels of the present invention are essentially like the stairs. The leading wheels encounter the obstacle at a higher level just as would a wheel of larger diameter. Force is applied in a small increment to lift the cart only to the small diameter of this leading wheel. Held in fixed position immediately behind this leading wheel is the second wheel of the caster. Again, a small increment of force is applied to lift the load to this sequentially higher level. The present invention should only need two leading wheels in most initial applications, but the sequence of wheels each have overcome the encountered obstacle. Because the final wheel is the small diameter of a conventional caster, the stability of the cart is not decreased. Instead, because the lifting force is applied sequentially in smaller steps, the stability of the cart increased.

The strength of the conventional caster wheel frame piece should be more than adequate to handle the smaller force loads of the present invention. This means that the frame for the present invention will require no significant increase in strengthening. What will be required is that the smaller diameter leading wheels are held in their strategic position relative to the conventionally located caster in the design. These wheels will need to be held in an ascending plane from the horizontal plane of the conventional caster wheel axle. The angle of this ascending plane can be application specific and variable. The ascending plane upon which the leading axles are to be mounted is to be a fixed plane.

Alternating vertical planes to the side of the first caster wheel allow the caster set and the caster housing to be more compact rather than all wheel axles being separated by a distance equal to the sum of the radius of the wheels in sequence if the casters were all aligned one after another in the same plane. The axle separation is reduced by placing sequential wheels to the side of the preceding wheel. The wheels overlap one another as they are mounted in parallel vertical planes therefore reducing the distance between axles.

An advantage of the present invention is that it easily rolls over a 2×4 board or any other type obstacle in its path, such as door thresholds and cables, that might normally lie in the path of rolling carts in an environment where they are being used.

Another advantage of the present invention is that the parallel offset wheel allows the wheel housing to be compact.

One more advantage of the present invention is that it provides the means for the wheels to swivel when necessary.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a side elevational view of the multiple wheel caster of the present invention;

FIG. 2 is a bottom plan view of the multiple wheel caster of FIG. 1 showing the side by side offset and front to back spacing of the wheels in the caster;

FIG. 3 is a schematic side elevational view showing the wheels of the multiple wheel caster going up over an obstacle;

FIG. 4 is a schematic perspective view showing the wheels of the multiple wheel caster going up over an obstacle;

FIG. 5 is an elevational view of a pair of multiple wheel casters of the present invention mounted on a cart with one mounted by a swivel and the other mounted by bolting the base plate of the housing to the underside of a cart.

### DETAILED DESCRIPTION OF THE INVENTION

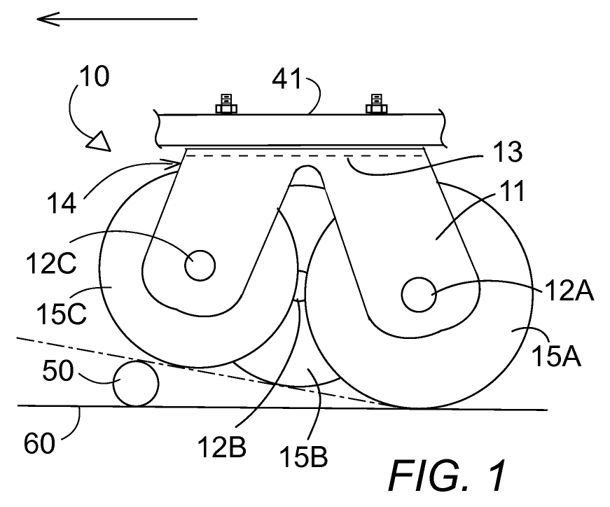

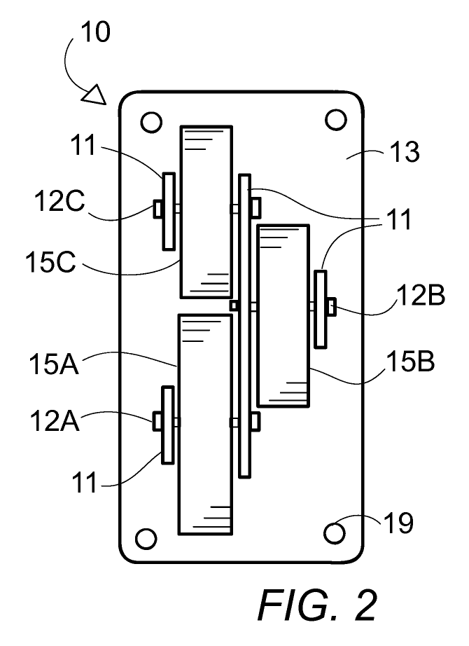

In FIGS. 1-5, a multiple wheel caster apparatus 10 for overcoming obstacles 50 in the path of travel while maintaining a low center of gravity comprise a plurality of multiple caster wheel housings 14 attached to a bottom of a movable object 41 for moving the object 40. The multiple caster wheel housings 14 support the movable object 40 in close proximity to an external surface 60 over which it is moving to maintain a low center of gravity. The multiple caster wheel housing 14 comprises at least three wheels 15A, 15B, and 15C with axles 12A, 12B, and 12C that attach to wheel supports 11.

In FIGS. 1-5, at least three caster wheels 15A, 15B, and 15C are attached to each of the caster wheel supports 11 by axles 12 to permit rotation of the wheels 15A, 15B, and 15C. The caster wheels 15 comprise at least one ground contacting caster wheel 15A positioned in the caster wheel housing 14 with the first caster wheel 15A normally contacting a ground surface 60 for normal travel over relatively smooth surfaces, and at least one elevated front caster wheel 15C positioned forward of and aligned in the same vertical plane with the at least one ground contacting caster wheel 15A. The elevated front caster wheel 15C is positioned higher than the ground contacting caster wheel 15A, so that the elevated front caster wheel 15C is normally not in contact with an even ground surface 60. At least one elevated offset caster wheel 15B is mounted in a parallel adjacent vertical plane to one side of and midway between the ground contacting caster wheel 15A and the elevated front caster wheel 15C to smooth the transition therebetween when traveling over an obstacle 50. The elevated forward caster wheel 15C is positioned at a height that allows it to ride up over an obstacle 50 in the path of travel, and allows all the following caster wheels to also ride smoothly up over obstacles without a need for excessive force or disturbance of any items which are being conveyed on the movable object 40.

In FIGS. 1-5, the caster wheels 15A, 15B, and 15C each have a different diameter in descending size from the largest diameter one of the ground contacting caster wheel 15A to the intermediate diameter of the elevated offset caster wheel 15B to the smallest diameter of the elevated forward caster wheel 15C to ease the transition between adjacent caster wheels passing over the obstacle 50.

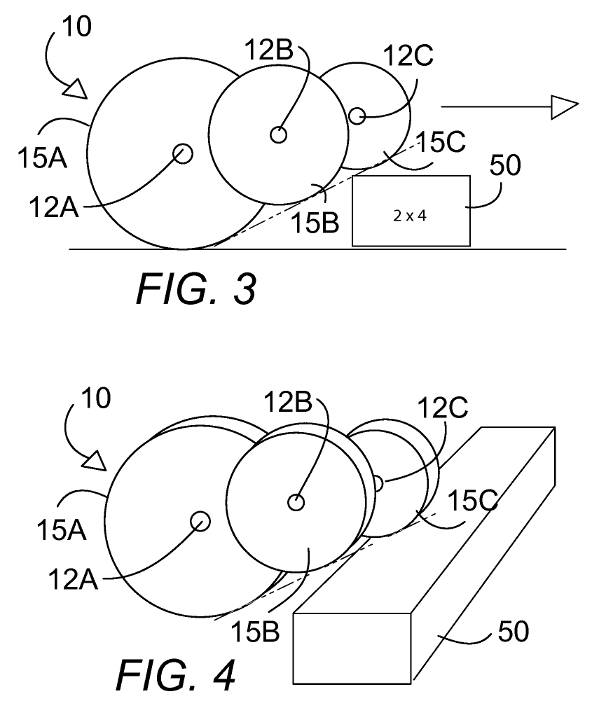

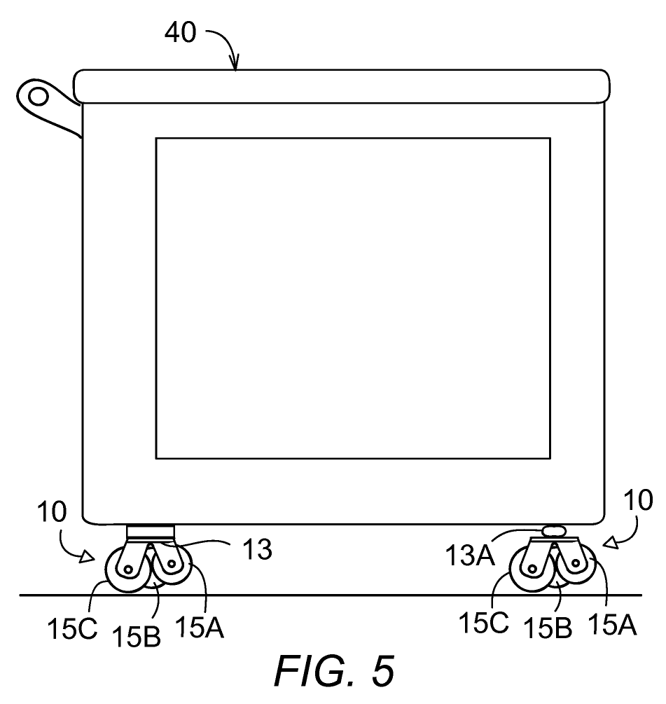

In FIGS. 3 and 4, wheels 15A, 15B, and 15C of the multi-wheel casters are shown schematically without the housings to show how the wheels easily ride up over an obstacle 50, including cables, door thresholds and even a 2×4 board because the smaller diameter front elevated wheel 15C is already at the height of the obstacle 50. Then the other two wheels 15B and 15A follow and ride easily over the obstacle.

The multiple caster wheel housings 14 may be mounted in side-by-side, spaced alignment each attached to the bottom 41 of movable object 40 by a stationery attachment of the base 13 to the bottom 41 of a cart 40 or other movable object to enable straight travel of the movable object 40, as shown in FIG. 1 and in the back multi-wheel caster 10 in FIG. 5.

The multi-wheelcaster 10 may be mounted to the movable object 40 by a swivel mechanism 13A to enable steering of the movable object, as shown on the right side of the cart in FIG. 5. All of the multi-wheel casters can be mounted to any movable object each by a swivel mechanism 13A to enable ease of steering of the movable object in a very short turning radius.

The diameter of all wheels 15, and the angle of the plane of their attachment, can vary and will be application specific. The housing pieces may vary in size and material and the composition of the caster wheels may be fabricated with variable levels of hardness or made pneumatic. The frame material can be as conventional as that presently in caster wheel applications, or varied to accommodate higher stress loads or environmentally specific conditions.

In use, the present invention can be applied for any present caster wheel use. These applications tend to be, but are not limited to the utility carts used in hospitals, hotels, delivery services, laundries, manufacturing, and construction and further including any furniture items having casters. This is not an exhaustive list, but it is limited categorically to those situations where caster wheels are found rolling over hard, flat floor surfaces.

In addition, the multi-wheel casters of the present invention can be applied to pneumatic wheeled carts, wagons, trailers, and similar utility carts in agriculture, landscaping, construction, mining, and oil refineries, and would be safer and more efficient if modified in accordance with the present invention.

The wheels of the present invention may be built in a variety of configurations to meet the needs of various different applications.

It is understood that the preceding description is given merely by way of illustration and not in limitation of the invention and that various modifications may be made thereto without departing from the spirit of the invention as claimed.

What is claimed is:

1. A multiple wheel caster apparatus for overcoming obstacles in the path of travel while maintaining a low center of gravity, the apparatus comprising:
a plurality of multiple caster wheel housings attached to a bottom of a movable object for moving the object, the multiple caster wheel housings supporting the movable object in close proximity to an external surface over which it is moving to maintain a low center of gravity;
at least three caster wheels attached to each of the caster wheel housings by means to permit rotation of the wheels, the at least three caster wheels comprising at least one ground contacting caster wheel positioned in the caster wheel housing with the first caster wheel normally contacting a ground surface for normal travel over relatively smooth surfaces; at least one elevated front caster wheel positioned forward of and aligned in the same vertical plane with the at least one ground contacting caster wheels and positioned higher than the at least one ground contacting caster wheel so that the at least one elevated front caster wheel is normally not in contact with the ground surface; and at least one elevated offset caster wheel mounted in a parallel adjacent vertical plane to one side of and midway between the at least one ground contacting caster wheel and the at least one elevated front caster wheel to smooth the transition therebetween when traveling over an obstacle, the at least one elevated forward caster wheel positioned at a height so that the at least one elevated forward caster wheel will ride up over an obstacle in the path of travel and all the following caster wheels ride smoothly up over obstacles without a need for excessive force to move the movable object and with out disturbance of any items which are being conveyed on the movable object.

2. The apparatus of claim 1 wherein the caster wheels each have a different diameter in descending size from the largest diameter at least one ground contacting caster wheel to the intermediate diameter at least one elevated offset caster wheel to the smallest diameter at least one elevated forward caster wheel to ease the transition between adjacent caster wheels passing over the obstacle.

3. The apparatus of claim 1 wherein at least one of the multiple caster wheel housings is mounted to the movable object by a swivel mechanism to enable steering of the movable object.

4. The apparatus of claim 1 wherein all of the multiple caster wheel housings are mounted to the movable object each by a swivel mechanism to enable ease of steering of the movable object in a very short turning radius.

5. The apparatus of claim 1 wherein at least one pair of the multiple caster wheel housings in side by side spaced alignment are each mounted to the movable object by a stationery attachment to enable straight travel of the movable object.
